(19) United States
(12) Patent Application Publication
(10) Pub. No.: US 2017/0171622 A1
(43) Pub. Date: Jun. 15, 2017

(54) METHODS AND CONTENT SYSTEMS, SERVERS, TERMINALS AND COMMUNICATION SYSTEMS

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Shengcai LIU, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/242,229

(22) Filed: Aug. 19, 2016

Related U.S. Application Data
(63) Continuation of application No. PCT/CN2016/089550, filed on Jul. 10, 2016.

(30) Foreign Application Priority Data
Dec. 15, 2015 (CN) 201510933629.6

(51) Int. Cl. H04N 21/466; H04N 21/45; H04N 21/25; H04N 21/81

(52) U.S. Cl. CPC H04N 21/4668; H04N 21/812; H04N 21/4532; H04N 21/25

(57) ABSTRACT

The present disclosure relates to the communications field, and disclose a method based on a video content recommendation and an electronic device. The method comprises: acquiring displayed content in the video and determining whether target content exists in the displayed content; acquiring a recommendation related to the target content; and providing the recommendation related to the target content in a play interface of the video when the video is played and shows the target content. By means of the embodiments of the present disclosure, when a video is played and shows target content, a recommendation related to the target content is provided in a play interface of the video, which can purposively recommend target content, improve a success rate of recommendation, and reduce popularization cost of the target content.

### CROSS-REFERENCE TO RELATED APPLICATIONS

The present disclosure is a continuation of PCT application No. PCT/CN2016/089525PCT submitted on Jul. 10, 2016. The present disclosure claims priority to Chinese Patent Application No. 201510933629.6, filed with the Chinese Patent Office on Dec. 15, 2015, which is incorporated herein by reference in its entirety.

### TECHNICAL FIELD

The present disclosure relates to the communications field, and in particular, to a method for recommending content based on a video and an electronic device.

### BACKGROUND

As a common media, a television always plays an important role in marketing and advertising. Merchants need to promote a commodity for sale to attract consumers to buy. The consumers also need to learn a purchase manner of a new commodity through advertisements.

A conventional marketing and promotion are by means of using a print media or television advertising. The print media refers to the media using a paper as a carrier to release news or information, for example, a newspaper and a magazine, and spread speed and coverage are relatively limited. Advantages of television advertising are broad coverage, fast spread speed, and a high delivery rate, and the television advertising simultaneously includes shapes, voice, colors, and dynamic states, and are vivid, intuitive, and easily acceptable, and have strong appeal. Disadvantages of the television advertising are: short play time, hard to be retained, a poor selection in recommended objects, and an absolutely high cost.

Therefore, problems of a poor selection in recommended objects and an absolutely high cost need to be resolved.

### SUMMARY

An objective of the present disclosure is to provide a method for recommending content based on a video and an electronic device, where the method can purposively recommend a commodity or a service for a subject having a latent requirement.

To achieve the objective, embodiments of the present disclosure provide a method for recommending content based on a video, where the method includes: acquiring displayed content in the video and determining whether target content exists in the displayed content, acquiring a recommendation related to the target content, and providing the recommendation related to the target content in a play interface of the video when the video is played and shows the target content.

An embodiment of this disclosure further provides a non-volatile computer storage medium, which stores computer executable instructions, where the computer executable instructions are used to execute any foregoing method for recommending content based on a video of this disclosure.

An embodiment of this disclosure further provides an electronic device, including: at least one processor; and a memory, where the memory stores instructions executable by the at least one processor, where execution of the instructions by the at least one processor causes the at least one processor to execute any foregoing method for recommending content based on a video of this disclosure.

Other features and advantages of the embodiments of the present disclosure are described in detail in a subsequent specific implementation manner part.

### BRIEF DESCRIPTION OF THE DRAWINGS

One or more embodiments are exemplarily described by using figures that are corresponding thereto in the accompanying drawings; the exemplary descriptions do not form a limitation to the embodiments. Elements with same reference signs in the accompanying drawings are similar elements. Unless otherwise particularly stated, the figures in the accompanying drawings do not form a scale limitation.

FIG. 1 is a flowchart of a method for recommending content based on a video according to an implementation manner of the present disclosure;

FIG. 2 is a schematic composition diagram of a communications system according to an implementation manner of the present disclosure; and

FIG. 3 is a schematic structural diagram of hardware of an electronic device for executing a method for recommending content based on a video provided in an implementation manner of this disclosure.

### DETAILED DESCRIPTION

The specific implementation manner of the disclosure is described below in detail with reference to accompanying drawings. It should be understood that the specific embodiment manners described herein are merely used to describe and explain the disclosure, and are not intended to limit the present disclosure.

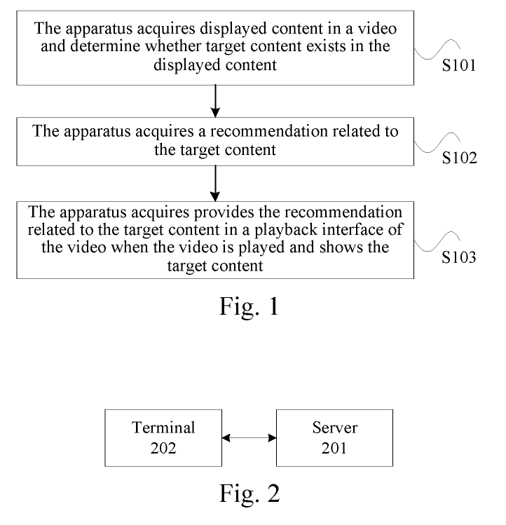

FIG. 1 is a flowchart of a method for recommending content based on a video according to an implementation manner of the present disclosure. As shown in FIG. 1, the embodiments of the present disclosure provide a method for recommending content based on a video, where the method may include: in S101, the apparatus acquires displayed content in the video and determine whether target content exists in the displayed content; in S102, the apparatus acquires a recommendation related to the target content; and in S103, the apparatus provides the recommendation related to the target content in a play interface of the video when the video is played and shows the target content.

A wide variety of content may be displayed in the video, and may include a physical object and a service. The physical object may be a commodity that has usage value and that may be sold, for example, food, clothing, a vehicle, and a dwelling. The service may be a virtual commodity provided by a service provider, for example, a communication service, a consulting service, and an intermediary service.

The content displayed in the video is various and cannot be recommended entirely. In other words, if all content is recommended may loses the meaning of the recommendation, which has no difference from recommending nothing. To make a purposive recommendation, content displayed in a video needs to be screened, and it is determined whether recommendable target content exists in the video. In an implementation manner, the commodity or the service classification displayed in the video may be used as the target content. For example, an object (for example, a mobile phone) used by a person in the video is used as the target content. In an embodiment, a specific classification of a particular object may be used as the target content. For example, a specific brand and/or a model number of the mobile phone displayed in the video may be used as the target content.

Selection of the target content may have multiple manners. For example, the target content may be popular content determined by using search statistics. In an implementation manner, a server storing the video may already acquire displayed content in the video, the server may determine, by using the search statistics (for example, a quantity of searching times) in the Internet, that network popular content having some popularity is used as the target content. Selection of the popularity may be based on statistics data. For example, a quantity of times of network searched content in a period of time (for example, a week) is ranked, and content of a rank (for example, top 100) is used as popular content. In another example, the target content may be set according to an interest of a viewer (or a user of a terminal for playing the video). For example, the user may input (for example, by using the terminal) content the user is interested in as the target content. In addition, the target content may also be set by a copyright owner of the video or a sponsor of the video.

After it is determined that the target content exists in the displayed content of the video, the server for storing the video may acquire a recommendation or recommendation information related to the target content, and an acquiring way may use, for example, the Internet or a recommendation database included in the server. Then, to provide the recommendation related to the target content for the viewer when the video is played and shows the target content, the recommendation related to the target content may be located to a time point at which the target content is displayed on a timeline of the video, or may be bound with the timeline. In this way, the video play terminal may provide, according to the time point, the recommendation related to the target content in a terminal play interface of the video when the video is played and shows the target content. Data of the recommendation related to the target content and video data may be compressed into streaming media for transmission. In different implementation manners, the server may separately send the data of the recommendation related to the target content and the video data to the video play terminal, and also provide a configuration file reflecting a relationship between the recommendation related to the target content and the timeline of the video to the video play terminal. In the implementation manner, the recommendation related to the target content may be an advertisement, for example, may be a description of the target content and/or a method for acquiring the target content. The description of the target content may be an introduction to a commodity, for example, may include a name, a price, a size, and a material of the commodity. The method for acquiring the target content may be, for example, a purchase address of the commodity, a manufacturer or a shopping platform link, and a contact number.

For example, the terminal or the video play terminal may be a device having a display/screen, such as a television, a tablet computer, and a smart phone. Because of a play feature of a video, a scenario or content in the video probably flashes by, to provide an effective recommendation for a viewer of the video, recommended content is continuously displayed a period of time in a play interface of the video play terminal. Therefore, in a preferable implementation manner, the recommendation related to the target content may be continuously provided in a predetermined time in the play interface of the video. The predetermined time may be set according to an actual requirement, for example, may be set according to a requirement of a provider of the target content, or may be set according to a time at which the target content occurs, so as to keep providing a recommendation related to previous target content before next target content is played in a video.

By means of the technical solutions, when a video is played and shows target content, a recommendation related to the target content is provided in a play interface, which can purposively recommend target content, improve a success rate of recommendation, and reduce popularization cost of the target content.

In another aspect of the embodiments of the present disclosure a system for recommending content based on a video is provided, where the system includes: a determining module, configured to acquire displayed content in the video and determine whether target content exists in the displayed content; a recommendation module, configured to acquire a recommendation related to the target content; and a display module, configured to provide the recommendation related to the target content in the interface of the video when the video is played and shows the target content.

In an implementation manner, the system further includes: a locating module, configured to locate the recommendation related to the target content to a time point at which the target content is displayed on a timeline of the video; and the display module, further configured to provide, according to the time point, the recommendation related to the target content in the play interface of the video when the video is played and shows the target content.

In an implementation manner, the system further includes: a keeping module, configured to keep providing the recommendation related to the target content in a predetermined time in the play interface of the video.

According to another aspect of the embodiments of the present disclosure, a server, a terminal, and a communications system are provided, and FIG. 2 shows an exemplary composition of the communications system. As shown in FIG. 2, the communications system may include: a server 201 and a terminal 202 that communicate with each other.

The server 201 may include: a determining apparatus, configured to acquire displayed content in a video and determine that target content exists in the displayed content; a recommendation apparatus, configured to acquire recommendation related to the target content; and a sending apparatus, configured to send acquired recommendation to the terminal.

The terminal 202 may include: a receiving device, configured to receive the video from the server and the recommendation related to the target content included in the video; and a display module, configured to provide there commendation related to the target content in a play interface when video is played and shows the target content.

In the system for recommending content based on a video provided in this implementation manner of the present disclosure, the terminal 202 and the server 201 may communicate to transmit data in a wired (for example, a network cable, a fiber, and a coaxial cable) or wireless(for example, WiFi and WiMAX) manner. For example, the server 201 may be any entity or virtual device having a computing and memory capability, such as a processor, a computer, and a cloud computing platform. For example, the terminal 202 may be a hardware device including a data transceiver unit, a video decoder, and a display/screen. In a preferable implementation manner, the terminal 202 may include an input unit, so that a user may input content of interest as the target content by using the terminal.

An implementation manner of this disclosure provides a non-volatile computer storage medium, which stores computer executable instructions, where the computer executable instructions can execute the method for recommending content based on a video in any one of the foregoing method embodiments.

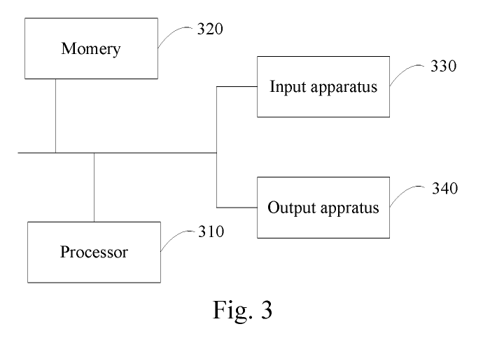

FIG. 3 is a schematic structural diagram of hardware of an electronic device for executing a method for recommending content based on a video provided in an implementation manner of this disclosure. As shown in FIG. 3, the electronic device includes: one or more processors 310 and a memory 320, where only one processor 310 is used as an example in FIG. 3.

An electronic device for executing the method for recommending content based on a video may further include: an input apparatus 330 and an output apparatus 340.

The processor 310, the memory 320, the input apparatus 330, and the output apparatus 340 can be connected by means of a bus or in other manners. A connection by means of a bus is used as an example in FIG. 3.

As a non-volatile computer readable storage medium, the memory 320 can be used to store non-volatile software programs, non-volatile computer executable programs and modules, for example, program instructions/module corresponding to the method for recommending content based on a video in the embodiments of this disclosure. The processor 310 executes various functional applications and data processing of the electronic device, that is, implements the method for recommending content based on a video of the foregoing method embodiments, by running the non-volatile software programs, instructions, and modules that are stored in the memory 320.

The memory 320 may include a program storage area and a data storage area, where the program storage area may store an operating system and an application that is needed by at least one function; the data storage area may store data created according to use of the server, and the like. In addition, the memory 320 may include a high-speed random access memory, or may also include a non-volatile memory such as at least one disk storage device, flash storage device, or another non-volatile solid-state storage device. In some embodiments, the memory 320 optionally includes memories that are remotely disposed with respect to the processor 310, and the remote memories may be connected, via a network, to the electronic device. Examples of the foregoing network include but are not limited to: the Internet, an intranet, a local area network, a mobile communications network, or a combination thereof.

The input apparatus 330 can receive entered digits or character information, and generate key signal inputs relevant to user setting and functional control of the electronic device. The output apparatus 340 may include a display device, for example, a display screen.

The one or more modules are stored in the memory 420; when the one or more modules are executed by the one or more processors 410, the method for recommending content based on a video in any one of the foregoing method embodiments is executed.

The foregoing product can execute the method provided in the embodiments of this disclosure, and has corresponding functional modules for executing the method and beneficial effects. Refer to the method provided in the embodiments of this disclosure for technical details that are not described in detail in this embodiment.

The electronic device in this embodiment of this disclosure exists in multiple forms, including but not limited to:

(1) Mobile communication device: such devices are characterized by having a mobile communication function, and primarily providing voice and data communications; terminals of this type include: a smart phone (for example, an iPhone), a multimedia mobile phone, a feature phone, a low-end mobile phone, and the like.

(2) Ultra mobile personal computer device: such devices are essentially personal computers, which have computing and processing functions, and generally have the function of mobile Internet access; terminals of this type include: PDA, MID and UMPC devices, and the like, for example, an iPad.

(3) Portable entertainment device: such devices can display and play multimedia content; devices of this type include: an audio and video player (for example, an iPod), a handheld game console, an e-book, an intelligent toy and a portable vehicle-mounted navigation device.

(4) Server: a device that provides a computing service; a server includes a processor, a hard disk, a memory, a system bus, and the like; an architecture of a server is similar to a universal computer architecture. However, because a server needs to provide highly reliable services, requirements for the server are high in aspects of the processing capability, stability, reliability, security, extensibility, and manageability.

(5) other electronic apparatuses having a data interaction function.

The apparatus embodiment described above is merely exemplary, and units described as separated components may be or may not be physically separated; components presented as units may be or may not be physical units, that is, the components may be located in a same place, or may be also distributed on multiple network units. Some or all modules therein may be selected according to an actual requirement to achieve the objective of the solution of this embodiment.

Through description of the foregoing implementation manners, a person skilled in the art can clearly learn that each implementation manner can be implemented by means of software in combination with a universal hardware platform, and certainly, can be also implemented by using hardware. Based on such understanding, the essence, or in other words, a part that makes contributions to relevant technologies, of the foregoing technical solutions can be embodied in the form of a software product. The computer software product may be stored in a computer readable storage medium, for example, a ROM/RAM, a magnetic disk, or a compact disc, including several instructions for enabling a computer device (which may be a personal computer, a sever, or a network device, and the like) to execute the method in the embodiments or in some parts of the embodiments.

Finally, it should be noted that: the foregoing embodiments are only used to describe the technical solutions of this disclosure, rather than limit this disclosure. Although this disclosure is described in detail with reference to the foregoing embodiments, a person of ordinary skill in the art should understand that he/she can still modify technical solutions disclosed in the foregoing embodiments, or make equivalent replacements to some technical features therein; however, the modifications or replacements do not make the essence of corresponding technical solutions depart from the spirit and scope of the technical solutions of the embodiments of this disclosure.

What is claimed is:

1. A method for recommending content based on a video, applied to an electronic device, comprising:
acquiring displayed content in the video, and determining whether target content exists in the displayed content;
acquiring a recommendation related to the target content; and
providing the recommendation related to the target content in a play interface of the video when the video is played and shows the target content.

2. The method according to claim 1, wherein after the determining the target content exists in the displayed content, the method further comprises:
locating the recommendation related to the target content to a time point at which the target content is displayed on a timeline of the video; and
providing, according to the time point, the recommendation related to the target content in the play interface of the video when the video is played and shows the target content.

3. The method according to claim 1, wherein the method further comprises: keeping providing the recommendation related to the target content in a predetermined time in the play interface of the video.

4. The method according to claims 1, wherein the target content is at least one of the following:
content of interest input by a user; and
popular content determined by using search statistics.

5. The method according to claims 1, wherein the recommendation related to the target content comprises at least one of the following: a description of the target content and a method for acquiring the target content.

6. A non-volatile computer storage medium, which stores computer executable instructions that, when executed by an electronic device, cause the electronic device to:
acquire displayed content in the video, and determining whether target content exists in the displayed content;
acquire a recommendation related to the target content; and
provide the recommendation related to the target content in a play interface of the video when the video is played and shows the target content.

7. The non-volatile computer storage medium according to claim 6, wherein after the instructions to determining the target content exists in the displayed content, when executed by an electronic device, cause the electronic device to:
locate the recommendation related to the target content to a time point at which the target content is displayed on a timeline of the video; and
provide, according to the time point, the recommendation related to the target content in the play interface of the video when the video is played and shows the target content.

8. The non-volatile computer storage medium according to claim 6, wherein the computer executable instructions are further used to: keep providing the recommendation related to the target content in a predetermined time in the play interface of the video.

9. The non-volatile computer storage medium according to claim 6, wherein the target content is at least one of the following:
content of interest input by a user; and
popular content determined by using search statistics.

10. The non-volatile computer storage medium according to claim 6, wherein the recommendation related to the target content comprises at least one of the following: a description of the target content and a method for acquiring the target content.

11. An electronic device, comprising:
at least one processor, and
a memory in connection and communication with the at least one processor, wherein
the memory stores instructions that may be executed by the at least one procesor, and the instructions are executed by the at least one processor, so that the at least one processor to:
acquire displayed content in the video, and determining whether target content exists in the displayed content;
acquire a recommendation related to the target content; and
provide the recommendation related to the target content in a play interface of the video when the video is played and shows the target content.

12. The electronic device according to claim 11, wherein after the execution of the instructions to determine the target content exists in the displayed content, cause the at least one processor to:
locate the recommendation related to the target content to a time point at which the target content is displayed on a timeline of the video; and
provide, according to the time point, the recommendation related to the target content in the play interface of the video when the video is played and shows the target content.

13. The electronic device according to claim 11, wherein the instructions are set to execute: keep providing the recommendation related to the target content in a predetermined time in the play interface of the video.

14. The electronic device according to claim 11, wherein the target content is at least one of the following:
content of interest input by a user; and
popular content determined by using search statistics.

15. The non-volatile computer storage medium according to claim 11, wherein the recommendation related to the target content comprises at least one of the following: a description of the target content and a method for acquiring the target content.
